(19) United States
(12) Patent Application Publication
(10) Pub. No.: US 2007/0058553 A1
(43) Pub. Date: Mar. 15, 2007

(54) Method and an arrangement for transport layer control signalling in utran supporting both atm and ip transport technologies

(76) Inventors: Csaba Antal, Kiskunlachaza (HU); Niilo Musikka, Bromma (SE); Attila Bader, Fot (HU); Lars Westberg, Enkoping (SE)

Correspondence Address: NIXON & VANDERHYE, PC, 901 NORTH GLEBE ROAD, 11TH FLOOR, ARLINGTON, VA, 22203, US

(21) Appl. No.: 10/578,489

(22) PCT Filed: Nov. 28, 2003
(86) PCT No.: PCT/SE03/01838

§ 371 Date: May 5, 2006

(51) Int. Cl. H04J 3/14; H04L 12/56

(52) U.S. Cl. 370/248; 370/401

(57) ABSTRACT

The present invention relates to a method and an arrangement for controlling the user plane of a UMTS Terrestrial Radio Access Network, UTRAN, comprising a first edge node connected via a Transport Network Layer to a second edge node, by using Transport Network Layer, TNL, signalling. A radio link is set up by using the Node B Application Part between the first and second edge nodes of the UTRAN, RSVP-TE based TNL signalling messages are transmitted between said first and second edge nodes for each TNL flow, and each TNL flow is identified by using RSVP-TE messages, wherein the object SESSION and SENDER_TEMPLATE comprises an IP based 5-tuple flow information, which is adapted to be used as a TNL flow identity.

### FIELD OF THE INVENTION

The present invention relates to a method and an arrangement in a mobile telephone network. In particular, it relates a method and an arrangement for transport network layer (TNL) control signaling in a Universal Mobile Telephony System Terrestrial Radio Access Network (UTRAN).

### BACKGROUND

UMTS Terrestrial Radio Access Network (UTRAN) is the Radio Access Network (RAN) of 3^{rd} generation mobile networks specified by 3GPP standardisation organization. The general protocol model of UTRAN Interfaces is shown in FIG. 2a. The protocol model can be split up into two logically independent layers: a Radio Network Layer (RNL) and a Transport Network Layer (TNL), and orthogonally into User and Control planes as further described in 3GPP TS 25.401, 3GPP, TSG RAN: UTRAN overall description.

According to FIG. 1, the main parts of the UTMS are a core network 101, the UTRAN 102, and user equipments (UE) 107 also referred to as mobile terminals. The interface between the core network 101 and the UTRAN 102 is called the Iu interface 108, and the interface between the UTRAN 102 and the user equipments 107 is called the Uu interface 111. The UTRAN 102 comprises a Radio Network Subsystems (RNS) 103. The interface between two RNSs is called the Iur interface 109. The RNS 103 comprises an RNC 104 and one or more Node Bs 105 also referred to as base stations. The interface between the RNC 104 and the Node B 105 is called the Iub interface 110. The coverage area of the Node B, i.e. cell, is denoted with 106.

As a general tendency, earlier versions of UTRAN are based on ATM while new versions will be based on IP technology. Mixed ATM and IP based networks are also possible. There are significant differences between the two transport technologies, which are the consequence that ATM is connection oriented while IP is connection-less transport method.

In ATM based UTRAN, user data uses AAL2 while TNL signalling uses AAL5 protocols. AAL2 and AAL5 connections are transported in Virtual Connections (VC) and Virtual Paths (VP), which are configured by management system or by ATM signalling. For different type of user traffic, different service categories are defined such as Constant Bitrate (CBR), Variable Bitrate (VBR), Unspecified Bitrate (UBR), which are characterized by different traffic parameters. The required Quality of Service (QoS) is ensured by Call Admission Control mechanism (CAC) running for each VP/VC.

IP will be introduced in future UTRAN releases, so a migration path has to be planned from ATM to IP. Smooth migration from ATM to IP transport technology in UTRAN requires the co-existence of ATM and IP based network parts. Interoperability between ATM and IP network parts for Iu, Iur, Iub interfaces as illustrated in FIG. 1 has to be provided. If the nodes do not support both ATM and IP technology an Inter-working Unit (IWU) has to operate between ATM and IP network parts.

The currently available and basic solution for Transport Network Control Plane for AAL2/ATM network is Q.2630 signalling as described in ITU-T Recommendation Q.2630.2: “AAL type 2 signalling protocol (Capability Set 2)”]. Q.2630 is used to establish AAL2 connections in ATM UTRAN network but Q.2630 signalling is not suitable to configure ATM layer. In ATM UTRAN permanent and semi-permanent VPs and VCs are used, which are configured manually by a management system.

In IP networks, packets are routed by standard IP routing protocols and IP based transport protocols provide reliable or not reliable transport service for IP packet delivery. For QoS provisioning in an IP network in which different traffic types are transported during the same time period, two fundamentally different architectures are developed: Integrated Services (IntServ) and Differentiated Services (DiffServ). In IntServ, resources in routers are provided for each traffic flow, while in DiffServ traffic types are classified based on their Per Hop Behaviour (PHB) and resources are provided usually per PHB.

Resource Management in DiffServ (RMD) method, described in L. Westberg et.al.: “Resource Management in DiffServ Framework”, Internet Draft, Work in Progress, 2001; L. Westberg et.al.: “Resource Management in DiffServ (RMD): A Functionality and Performance Behavior Overview”, Protocols for High Speed Networks, 2002, Berlin may be used for dynamic resource management in IP networks. In RMD, resource management is done in two scales: per flow reservation is done in edge node while per traffic class reservation, or measurement based reservation is done in edge nodes. The mayor advantage of RMD comparing to IntServ based reservation methods is its scalability and lightweight protocol implementation in interior nodes.

For TNL Control in IP based UTRAN network, the IP based TNL Signalling protocol IP-ALCAP is used. IP-ALCAP is under specification in 3GPP [3GPP TSG RAN WG3: R3-021366“A2IP Signalling Protocol (Q.IPALCAP Spec. draft)” 2002; WO 03/019897 A1 shows a solution for interworking between IP-ALCAP and Q.2630. QoS is ensured by resource over-provisioning in IP routers or by using complex resource reservation schemes that require reservation states for each connection, for example using IntServ method in IP-ALCAP. The available protocol Stacks in TNL Control Plane and User Plane are shown in FIG. 2a, for the Iub Interface.

The motivations to introduce IP transport in UTRAN are e.g. that it provides better support of mixed traffic types in narrow links, an increasing number of IP based applications, and IP based operating and maintenance. Further advantages are that IP is independent of data-link layer, high deployment of IP routers reduces their price, and that dynamic update of routing tables and auto-configuration capabilities may be used

Mixed ATM and IP transport is also possible. In a typical mixed ATM-IP network the Higher Layer RAN (HRAN) is IP based and the Lower Layer RAN (LRAN) is ATM based and an Inter-working Unit (IWU) operates between the ATM and IP network parts. In the IWU, Q.AAL2 and IP-ALCAP messages have to be translated. See FIG. 2b.

Examples of drawbacks of the IP-ALCAP solution described above are listed below:

Standard IP-routing protocols do not inter-operate with IP-ALCAP. IP-ALCAP is based on per-hop bi-directional connection establishment, like Q.2630, therefore the routing is static. In case of a link or a node failure or in case of congestion in a link, connections has to be terminated and a new connection has to be established between the RNC and the Node B.

It is not suitable to use IP-ALCAP for making resource reservations in IP routers and Diffserv based resource reservation scheme like RMD cannot be used. In addition, it is not possible to use IP-ALCAP soft-state resource management, as in RSVP.

The standard solutions for ATM/AAL2 based UTRANs also described above have the following drawbacks:

To allow dynamic setup of ATM VCs, an ATM signalling protocol is needed, which is independent of Q.AAL2 signalling used for establishing user connections. As VCs configuration changes rarely, it is not worth to implement a separate signalling protocol for this purpose. Therefore, ATM layer VCs and VPs are typically configured manually via the management system.

A mixed IP and ATM/AAL2 network suffers from the following drawbacks:

In a mixed ATM-IP network, two different protocols have to be used to set up an AAL2 connection: Q.AAL2 in the ATM part and IP-ALCAP in IP part. Inter-working function for TNL Control Plane is needed between ATM and IP part.

In a mixed ATM-IP network, two addressing structures are used, IP addressing in the IP part and ATM End System Addresses (AESAs) in the ATM part, which complicates addressing. In the RNC, the address translation between the IP and the ATM is needed and the ATM and the IP address tables have to be maintained.

Migration from ATM to IP is possible only in large steps, with significant immediate investment: In the IP part, both hardware and software for control plane have to be replaced. Future Link Layer technologies, such as Ethernet, MPLS, optical switching will require the implementation of new TNL signalling protocols.

### SUMMARY OF THE INVENTION

Thus, an object of the present invention is to provide an improved transport network control signalling that overcomes the above-mentioned drawbacks.

That is achieved by a method according to claim 1 and an arrangement according to claim 19.

Preferred embodiments of the invention are defined by the dependent claims.

Advantages with the present invention are the following:

The present invention makes it possible to use standard IP based routing and management, which allows more auto-configuration and more flexible fault handling. By using RSVP-TE extended with RMD objects, it is possible to perform DiffServ based resource reservation.

The present invention is also adapted for bi-directional signalling and soft reservation states may be used which results in simpler signalling and more robust design.

Introduction of RSVP-TE based signalling offers smaller migration steps from ATM to IP. As a first migration step, Control Plane may be changed to IP based RSVP-TE, requiring only software update in RNC and Node B. Then User Plane can be changed to IP starting from HRAN. Future Link Layer technologies, such as Ethernet, MPLS, optical switching, may also be adopted to UTRAN more easily. Thus, the RSVP-TE based signalling solution may be used to control AAL2/ATM TNL in UTRAN. The signalling solution according to the present invention may also be used to control mixed AAL2/ATM and IP based TNL in UTRAN, therefore no inter-working function or very lightweight inter-working function in TNL is required in the mixed IP-ATM based UTRAN.

ATM and AAL2 layers can be controlled by one protocol, in contrast to the prior art solution, in which Q.AAL2 signalling is used for controlling the AAL2 layer and a management system is used to configure the ATM layer.

Another advantage with the solution according to the present invention is that it is possible to perform dynamic configuration of the ATM layer while in the prior art solution with Q.AAL2 and the management system, permanent VCs and VPs are used.

IP, ATM and AAL2 layers can be controlled by one protocol. This feature reduces required signalling and operating and maintenance costs.

Since a standard IP based management system is used, IP addressing and DNS naming structures are used which implies that the ATM ASEA is not required.

In AAL2/ATM part the same AAL2 Admission Control can be used as in case of Q.AAL2 signalling.

### BRIEF DESCRIPTION OF THE DRAWINGS

For a more complete understanding of the invention, reference is made to the following detailed description taken in conjunction with the accompanying drawings wherein:

FIG. 1 illustrates schematically a UTRAN wherein the present invention may be implemented.

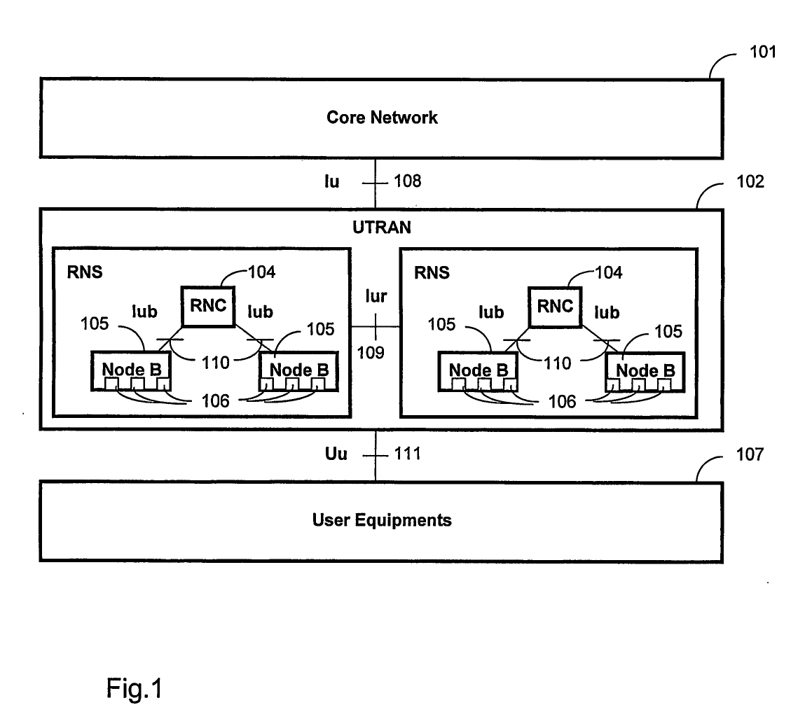

FIG. 2a shows schematically the logical splitting of the UTRAN protocol model.

FIG. 2b shows schematically a migration step from ATM to IP in a UTRAN. HRAN is IP based and LRAN is AAL2/ATM based. TNL control plane is IP-ALCAP and Q.AAL2.

FIG. 3a is a signalling scheme in an IP based UTRAN according to an embodiment of the present invention.

FIG. 3b is a signalling scheme in a mixed IP/ATM UTRAN according to an embodiment of the present invention.

FIG. 4a is a signalling scheme for a unidirectional reservation according to an embodiment of the present invention.

FIG. 4b is a signalling scheme showing a two-pass PATH and RESV messages for a bidirectional reservation according to an embodiment of the present invention.

FIG. 5 is a table with objects sent in the PATH and RESV messages.

FIG. 6 illustrates schematically the objects LABEL_REQUEST and LABEL objects with AAL2 label range according to one embodiment of the present invention.

FIG. 7 is a flowchart of the method according to the present invention.

### DETAILED DESCRIPTION OF PREFERRED EMBODIMENTS OF THE PRESENT INVENTION

The present invention will now be described more fully hereinafter with reference to the accompanying drawings, in which preferred embodiments of the invention are shown. This invention may, however, be embodied in many different forms and should not be construed as limited to the embodiments set forth herein; rather these embodiments are provided so that this disclosure will be thorough and complete, and will fully convey the scope of the invention to those skilled in the art. In the drawings, like numbers refer to like elements.

The Transport Network Layer (TNL) signalling solution according to the present invention is adapted for implementation in a UMTS Terrestrial Radio Access Network (UTRAN) TNL. The UTRAN comprises at least one RNC connected to at least one Node B via the TNL as described above. The TNL signalling according the present invention is based on the standard IP resource reservation-traffic engineering protocol, RSVP-TE, which is the extension of RSVP to support label switched tunnels described in R. Braden et. al.: Resource ReSerVation Protocol (RSVP)—Version 1 Functional Specification, RFC 2205, September 1997; D. Awduche: Extensions to RSVP for LSP Tunnels, RFC 3209, December 2001. RSVP-TE signalling is performed each flow connection and standard RSVP-TE messages and objects are used.

One of the functionalities required by the TNL signalling is flow identification. For each connection, TNL signalling messages has to contain the flow identification information. In accordance with the current RSVP-TE messages standard SESSION object carries Node B IP address, UDP port number and protocol ID. SENDER_TEMPLATE includes RNC IP address and UDP port number. In this way SESSION and SENDER_TEMPLATE are the objects that contain the IP-based 5-tuple flow information. That identity is in accordance with the present invention used for flow identification in the TNL signalling in a UTRAN. SESSION and SENDER_TEMPLATE information is processed by the edge nodes such as the Node B or the IWU, but not in interior nodes.

Thus, the present invention relates to a method and an arrangement for controlling the user plane of a UMTS Terrestrial Radio Access Network, UTRAN, comprising a first edge node connected via a Transport Network Layer to a second edge node, by using Transport Network Layer, TNL, signalling wherein a radio link is set up by using the Node B Application Part between the first and second edge nodes of the UTRAN, RSVP-TE based TNL signalling messages are transmitted between said first and second edge nodes for each TNL flow, and each TNL flow is identified by using RSVP-TE messages, wherein the object SESSION and SENDER_TEMPLATE comprises an IP based 5-tuple flow information, which is used as a TNL flow identity.

In accordance with a first embodiment of the present invention, the TNL signalling solution is adapted for implementation in an IP based UTRAN. One RSVP-TE tunnel is established for each connection and standard RSVP-TE objects and messages are used as mentioned above. In order to achieve bi-directional reservation, one tunnel is established for downstream and another tunnel for upstream user traffic.

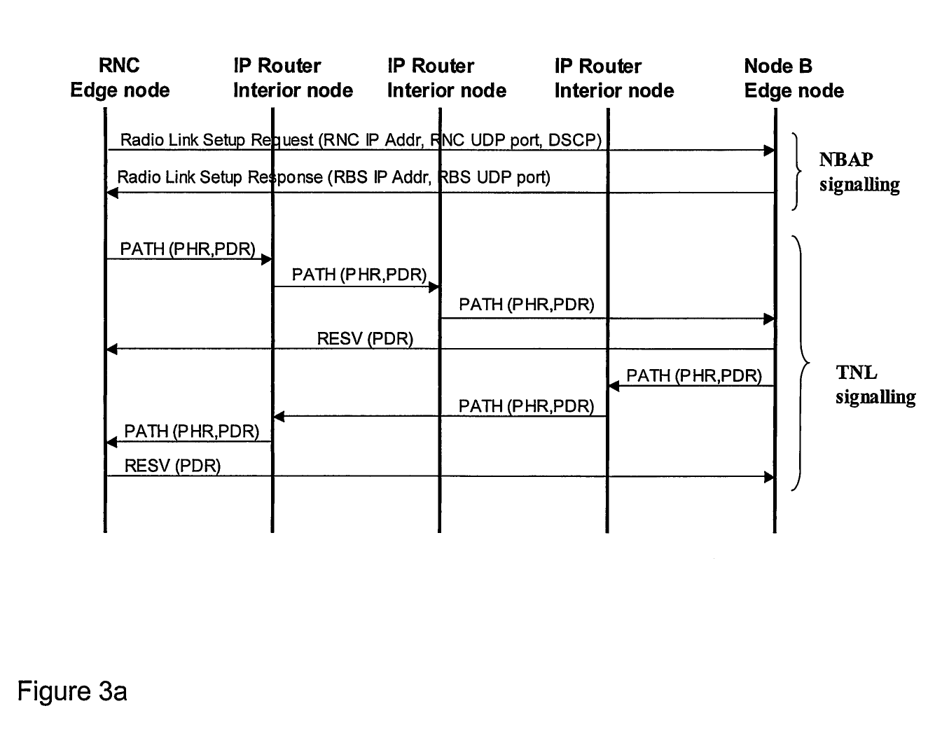

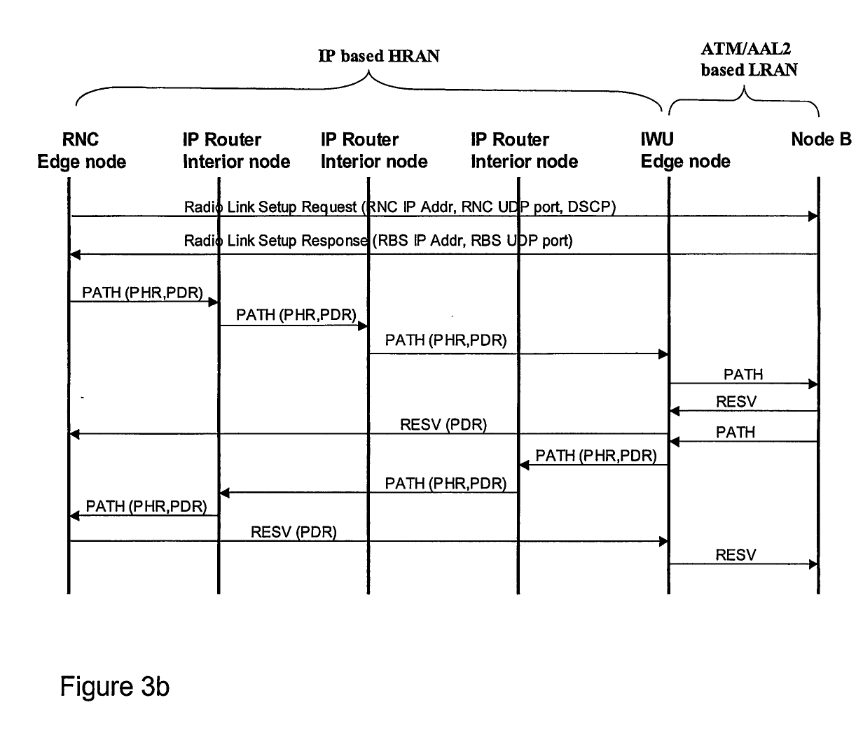

The network model between the RNC and the Node B in case of a full IP based network according to the first embodiment of the present invention is shown in FIG. 3a. It comprises an RNC, a Node B (also denoted base station) and interior routers. The RNC and the Node B are edge nodes using the terminology of the RMD concept.

The solution according to first embodiment of the invention may also be used in the case of mixed IP/ATM network, in which an Inter-working Unit (IWU) is adapted to operate between the IP and the ATM network parts. This scenario is shown in FIG. 3b. In this case the IWU is the edge of the RMD domain.

Referring to FIGS. 3a and 3b, the radio link connections are set up by Node B Application Part (NBAP) signaling between the RNC and the Node B in accordance with prior art. The setup is initiated at the RNC that sends a Radio Link Setup Request. The request is answered by the Node B in a Radio Link Setup Response message. In the NBAP signalling, the IP addresses and the UDP port number are exchanged, as shown in FIGS. 3a and 3b. Optionally, a DiffServ Code Point (DSCP) may also be transmitted.

Bi-directional resource reservation is established by the TLN messages, the two-pass PATH message and the two-pass RESV message, as shown in the FIGS. 3a and 3b. Two functionalities that the TNL signalling have to provide is flow definition and resource reservation.

The flow identification is performed as described above according to the present invention. In addition PDR objects contain the flow identity as described above, which is a combination of the source and destination edge node IP addresses and the DSCP field.

The message sequences to establish a bi-directional connection are shown in FIGS. 3a and 3b. In the RMD domain, the messages are routed by standard routing protocols both upstream and downstream. Unlike to standard RSVP and RSVP-TE concepts, per hop routing states are not stored in the routers in the RMD domain. RSVP-TE messages arranged to contain standard RSVP-TE objects and two objects i.e. PHR and PDR which are further described below, are in accordance with the first embodiment introduced in order to perform resource reservation in accordance with the “Resource Management in DiffServ” (RMD) method. The resource reservation is required in order to provide QoS. The PHR and the PDR objects are defined in the RMD concept disclosed in L. Westberg et.al.: “Resource Management in DiffServ Framework”, Internet Draft, Work in Progress, 2001; L. Westberg et.al.: “Resource Management in DiffServ (RMD): A Functionality and Performance Behavior Overview”, Protocols for High Speed Networks, 2002, Berlin.

The resource reservation scheme of the first embodiment of the present invention is based on the RMD framework. In RMD, only edge nodes, such as RNC and IWU as in the mixed IP and ATM/AAL2 network as shown in FIG. 3b, use complex reservation methods and maintain per flow resource reservation states. In interior nodes such as IP routers as indicated in FIGS. 3a and 3b, it is suitable to use only very simple resource reservation methods, e.g. summing resource units and it is suitable to maintain only aggregated reservation states.

The RSVP-TE messages are adapted to contain, standard RSVP-TE objects and RMD specific objects: PHR and PDR objects. The RNC initiates the signalling by sending a PATH message towards Node B. The PATH message includes a PDR object and a PHR object. PHR contains simple reservation information such as bandwidth for interior nodes and for downstream direction. The PDR object contains the flow identity, as it is described above, and it may also contain resource reservation information for an upstream reservation. The PHR object is processed in each interior node passing by and the reservation is made. The PDR object, sent by the RNC, is processed only at the edge nodes, i.e. the at Node B or at the IWU.

After processing the PATH message in the Node B, the B responds with a RESV message. In the RMD domain, the RESV message is routed by standard routing protocols, while outside of the RMD domain, the RESV message is sent subsequently to the PATH message in the reverse direction as in the case of RSVP. Different routing is used inside and outside of the RMD domain. Inside of the RMD domain, standard IP routing is used such as OSPF or BGP. Outside the RMD domain, routing is done as in case of RSVP: PATH installs transport states in routers (IP address and port number of previous hop are stored) and RESV is sent to this address. In this way RESV follows the same route as PATH in reverse direction. There is difference between the methods used inside and outside of RMD domain if the upstream and downstream IP routes are different (IP routing is not symmetric). The edge node, i.e. Node B in the full IP case shown in FIG. 3a or the IWU in the case of mixed ATM/IP as shown in FIG. 3b, inserts a PDR object into the RESV message. This PDR object contains reservation confirmation information.

A PATH message is also sent by Node B. The edge node (Node B in full IP case or IWU in case of mixed ATM/IP) inserts a PHR and a PDR object for resource reservation in upstream direction. PHR is processed in each interior node while PDR only in the RNC. Resource reservation is done in the same way as in case of downstream direction.

After receiving PATH, RNC sends a RESV message back to the Node B. A PDR object, containing reservation confirmation information may be sent to edge node in RESV.

The reservation states in the DiffServ domain are soft states, which are refreshed periodically during time of the connection. Refreshment of the resources in the RMD domain is done by sending PATH messages as it is described in RSVP-TE and RMD framework. Not-refreshed resources are removed after the time-out period.

Tear down and fault-handling operations follow the scheme of RMD and message operation can be derived in the same way as in case of basic operation.

According to a second embodiment of the present invention, the TNL signalling comprises an extension of RSVP-TE to be used in the ATM/AAL2 domain of the UTRAN. I.e., it is possible to use one single control protocol regardless of the transport technology, i.e IP and/or ATM/AAL2. Therefore, in a network in which mixed AAL2/ATM and IP transport solutions are used, the IWU is not required in the TNL Control Plane between the ATM/AAL2 network and the IP network. However, the TNL signalling in accordance with the second embodiment requires additional objects in addition to the current RSVP-TE and also in addition to the TNL signalling in accordance with the first embodiment of the invention. These additional objects must however be excluded in the IP domain to ensure proper operation. To enable the application of AAL2 admission control functions used in one of the releases of UTRAN, the TNL signalling also comprises a possible usage of already existing objects of RSVP-TE.

The TNL signalling according to the second embodiment is in the following way:

The TNL signalling is adapted to control both ATM and AAL2 layers of AAL2 switches. So, the establishment of a new AAL2 connection may initiate the creation or modification of ATM VCs.

Moreover, the TNL signalling may also be adapted to control the AAL2 layer only. The ATM layer of AAL2 switches is configured semi-permanently by standard RSVP-TE or via the management system. This is denoted as RSVP-TE(ATM) and is performed according to prior art.

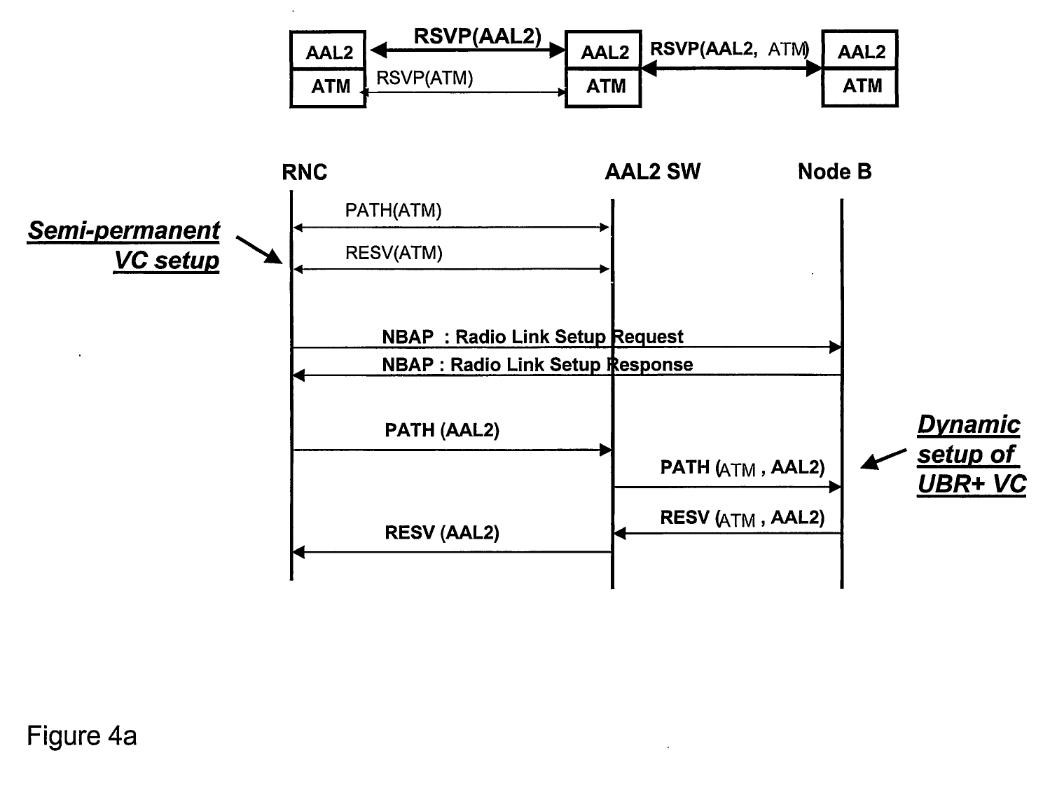

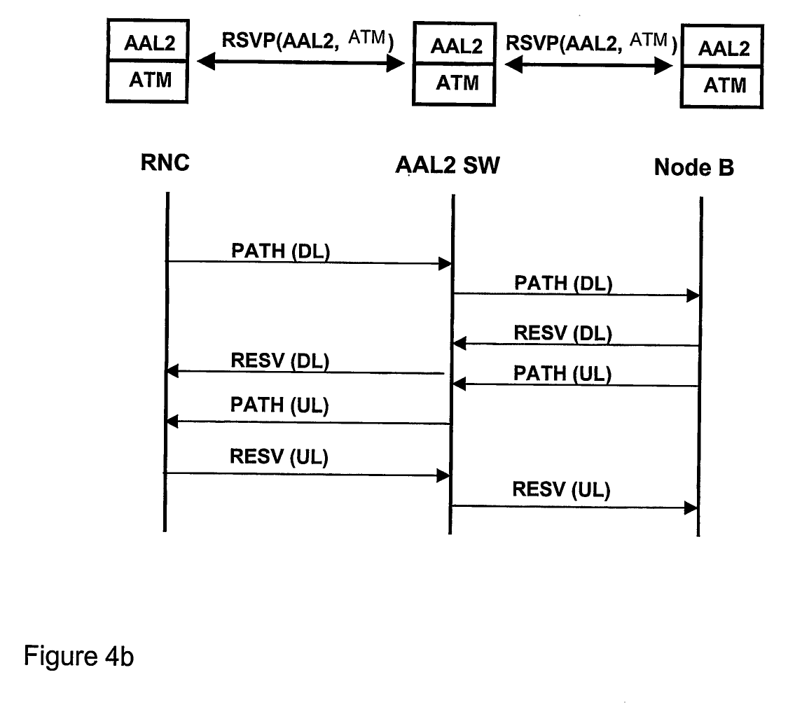

The model of the UTRAN between an RNC and a Node B and a basic unidirectional signalling operation are shown in FIG. 4a in the network part between the RNC and ALL2 switch, indicated in FIG. 4a, the ATM network layer is semi-permanent while the other part (between AAL2 switch and Node B) it is set up dynamically on-demand. (Could you explain this further. I don't understand the figure with the arrows.) This means that between RNC and AAL2 switch only the AAL2 layer is controlled by RSVP-TE signalling (ATM layer is controlled by e. g. network management system), while between AAL2 SW and Node B both AAL2 and ATM are controlled by RSVP-TE. This is indicated in FIGS. 4a and b by PATH(AAL2) vs PATH(ATM, AAL2), etc. This is further explained in the next paragraph. In the semi-permanent part CBR, VBR or UBR⁺ VCs can be used, while in the dynamic part UBR⁺ VCs are considered.

The radio link connections are set up according to prior art by NBAP signalling between the RNC and the Node B as in the first embodiment of the invention.

RSVP-TE signalling is according to the present invention performed for each AAL2 connection. To distinguish the protocol functionality and protocol messages in different parts of the network, the protocol messages are denoted by RSVP-TE(AAL2) in the ATM/AAL2 part in which ATM VCs are set up (semi-)permanently, and RSVP-TE(ATM,AAL2) in the ATM/AAL2 part in which both ATM and AAL2 layers are set up dynamically.

Considering the RSVP-TE functions, the RNC is the sender and the Node B is a receiver in FIG. 4a. In the standard RSVP-TE, resource reservation is performed by the receiver in the reverse direction. Since the RNC in UTRAN possesses all the flow identification and reservation information, practically all relevant information is signalled from the RNC. The Node B acts as a proxy reflecting the received information if necessary in order to comply with the current standard.

Three functions that the ATM/AAL2 TNL signalling is required to provide are (1) flow identification (2) AAL2/ATM layer configuration and (3) QoS provisioning.

The flow identification of control messages is performed as described above in accordance with the present invention.

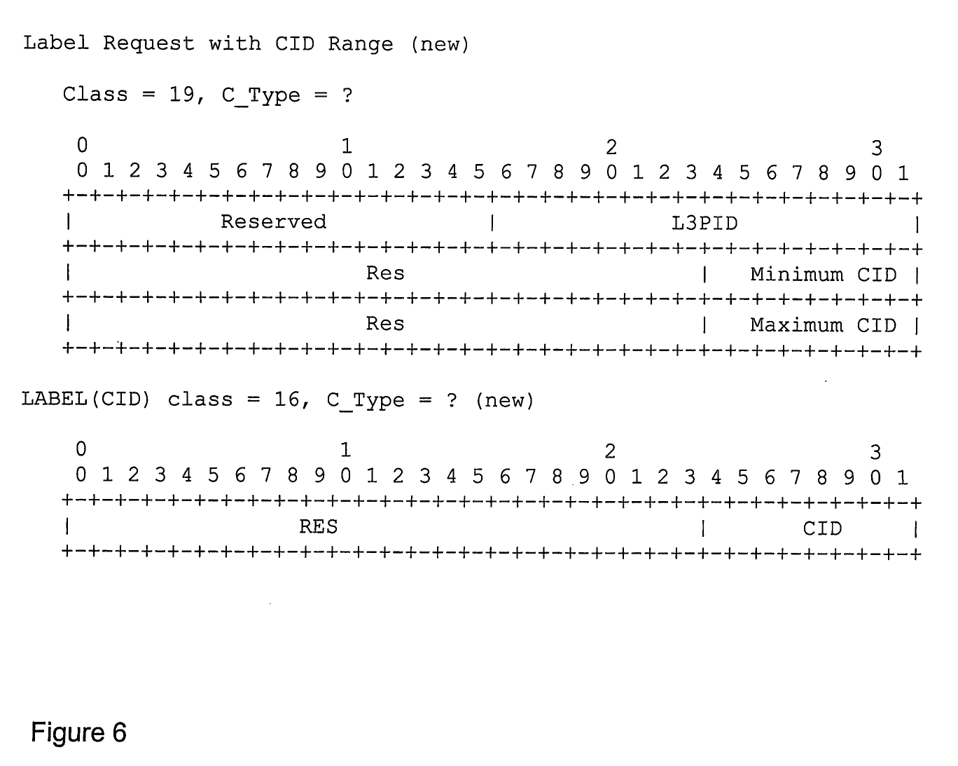

In order to configure the ATM/AAL2 network part, CID, VPI/VCI values have to be signalled between adjacent nodes along the path of the AAL2 connection. To achieve this, a LABEL_REQUEST with ATM Label Range (standard RFC 3209) is sent to the next ATM/AAL2 switch, which can choose a label from this range to be used on the specific link. For AAL2 configuration, a new class type must be defined, which in accordance with the second embodiment of the present invention is denoted AAL2_LABEL_REQUEST. AAL2_LABEL_REQUEST is sent in the PATH message to the next AAL2 switch indicating the AAL2 label range (i.e. CID range), from which the next hop AAL2 switch can select a single value. The form of this defined object is disclosed in FIG. 6.

In the RESV message, the ATM and the AAL2 label requests are answered by sending two LABEL objects in the RESV message: ATM LABEL object contains VPI and VCI while AAL2 LABEL objects contains CID of the connection. LABEL and AAL2_LABEL objects are processed by the same nodes in which LABEL_REQUEST and AAL2_LABEL_REQUEST were originated. The way the above objects are used depends on whether the ATM layer is configured dynamically or not.

If the ATM layer is configured statically then the new connection must use an already existing VC. Therefore, the AAL2 switches have to select a VPI/VCI pair that belongs to an existing VC, which has enough resources for the new AAL2 connection. If there is no VC with sufficient resources e.g. with no available CID value or with not enough free capacity then the call is blocked.

If both ATM and AAL2 are configured dynamically, then two cases are possible. If there is an already established VC with sufficient resources then it may be used i.e. the AAL2 switches select its VP/VC identifier. Otherwise a new VC should be established together with the new AAL2 connection. That is, a new VPI/VCI is selected by the AAL2 switches. Note that VCI, VPI or CID can be assigned explicitly by the sender if the range is limited to one value.

In he ATM/AAL2 network part, QoS is ensured by AAL2 CAC. One of the objects of the second embodiment is to minimize new implementation in the ATM/AAL2 nodes, e.g. to avoid the development of a new CAC algorithm. The AAL2 CAC algorithm in one release of UTRAN, AAL2 switches has the following parameters: number of sources, link capacity, packet size, Transmission Time Interval (TTI), activity factor, QoS class, delay and loss requirement, segment size and priority level. From these parameters only packet size, TTI, activity factor, QoS class and priority level is signalled by Q.AAL2 in the prior art. The other parameters are either configured (e.g. link capacity) or measured (e.g. number of sources).

Assuming that the TNL signalling according to the second embodiment has to signal the same AAL2 CAC parameters as the Q.AAL2. This can be performed by properly filling in the DSCP field and token bucket descriptors.

The token bucket descriptors are signalled in the object SENDER_TSPEC and in the object FLOW_SPEC. The object SENDER_TSPEC is sent in the PATH messages containing IntServ traffic descriptors of the user traffic. This traffic information is used in the receiver node of the flow to define the object FLOW_SPEC, which is sent back in the RESV message. The actual reservation is based on traffic parameters specified in the FLOW_SPEC object. Since multicast is not supported, FLOW_SPEC is practically identical to SENDER_TSPEC.

The DCLASS object contains DSCP of the flow. Assuming that the DSCP is exchanged in the NBAP signalling, which means that the Node B is able to put the proper value into the RESV messages. FLOW_SPEC and DCLASS are supposed to be used by AAL2 CAC for admission control decision. CAC parameters signalled in FLOW_SPEC object are packet size (bucket size) and TTI (bucket size/token rate). Priority level and QoS class is signalled in the DCLASS object. Thus, the only remaining CAC parameter that is signalled by Q.AAL2 but not mapped to RSVP-TE yet is activity factor. Activity factor cannot be obtained from standard IntServ token bucket parameters. This may be performed according to embodiment of the invention in three ways. Firstly, the Activity factor values are configured in the AAL2/ATM nodes and DSCP and other traffic descriptors are used for classification. Secondly, it is signalled in one of the unused field of TSPEC and FLOW_SPEC, and finally a new field or object are defined to signal the value of the Activity factor. However, the Activity factor may also be obtained by another method, which is obvious for a man skilled in the art.

An example of a successful establishment of a bi-directional connection is disclosed below. Unsuccessful Setup, Refresh, Tear Down operations are also based on standard RSVP-TE features and may be derived from the following example. When assuming asymmetric routing, which means that the route of the UpLink (UL) and the DownLink (DL) traffic may be different. This requires the two-pass PATH message flow and the two-pass RESV message flow, as it is shown in FIG. 4b. The RESV message for the DL flow may be sent the same time as the PATH message for the UL flow. Note that this bidirectional reservation is made up from two independent uni-directional reservations. Therefore, the flow identifiers of the two directions are different and the assigned labels of the two directions on the same link may also differ.

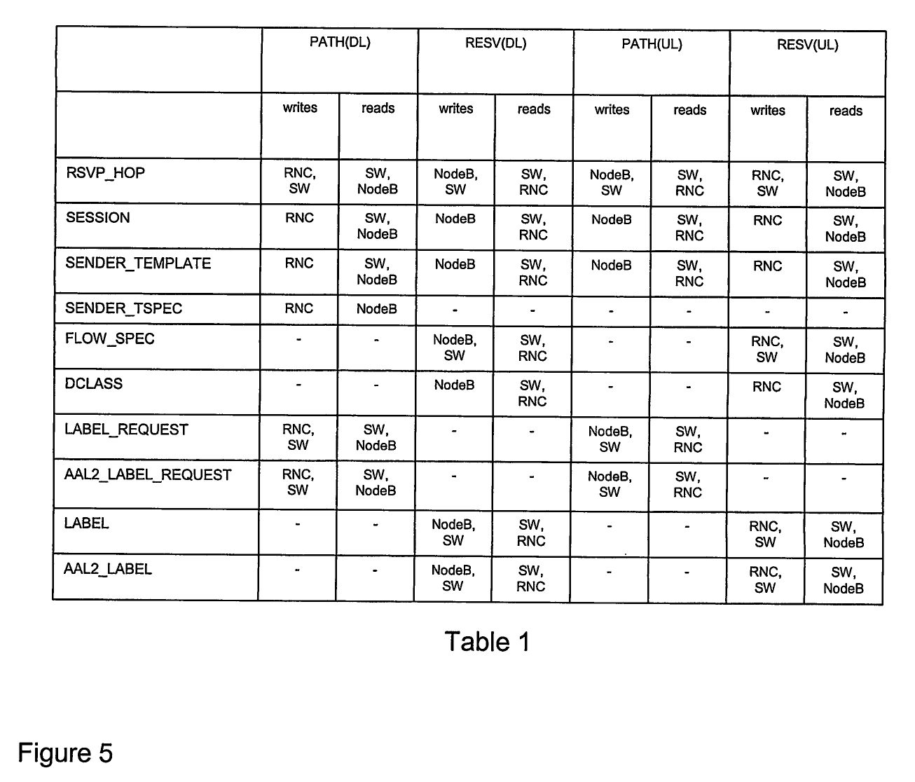

In the table in FIG. 5, the most important objects sent in PATH and RESV messages are described. The table also indicates which nodes read and which ones write the listed objects. In the case of the UTRAN, one problem is for the Node B to fill in the objects for the uplink reservation (i.e. SENDER_TEMPLAT, SESSION, SENDER_TSPEC). Accordingly, the Node B must fill in the objects SENDER_TEMPLATE and SESSION for the PATH message that belongs to the uplink reservation. A solution is according to the second embodiment of the present invention that the IP address and the port are copied from the SENDER_TEMPLATE of PATH(DL) to the SESSION object of PATH(UL) and the IP address and port from the SESSION object of PATH(DL) are copied to SENDER_TEMPLATE of PATH(UL).

The other object that is related to uplink reservation is the SENDER_TSPEC object. According to the normal operation, the receiver assigns the content of the FLOW_SPEC object in accordance with the information received in the object SENDER_TSPEC. For uplink reservation, the RNC is arranged to fill in the FLOW_SPEC object based on local information while ignoring the SENDER_TSPEC object sent by the Node B. LABEL_REQUEST, AAL2_LABEL REQUEST, LABEL and AAL2_LABEL objects are used in the same way as in the case of unidirectional reservations.

The objects LABEL_REQUEST and the object LABEL with AAL2 label range are defined according to the second embodiment of the present invention. Said objects are defined in a similar way as LABEL_REQUEST and LABEL objects with ATM label range described in RFC 3209 [D. Awduche: Extensions to RSVP for LSP Tunnels, RFC 3209, December 2001]. The less significant 8 bits contain Channel Identification (CID) value, as shown in FIG. 6.

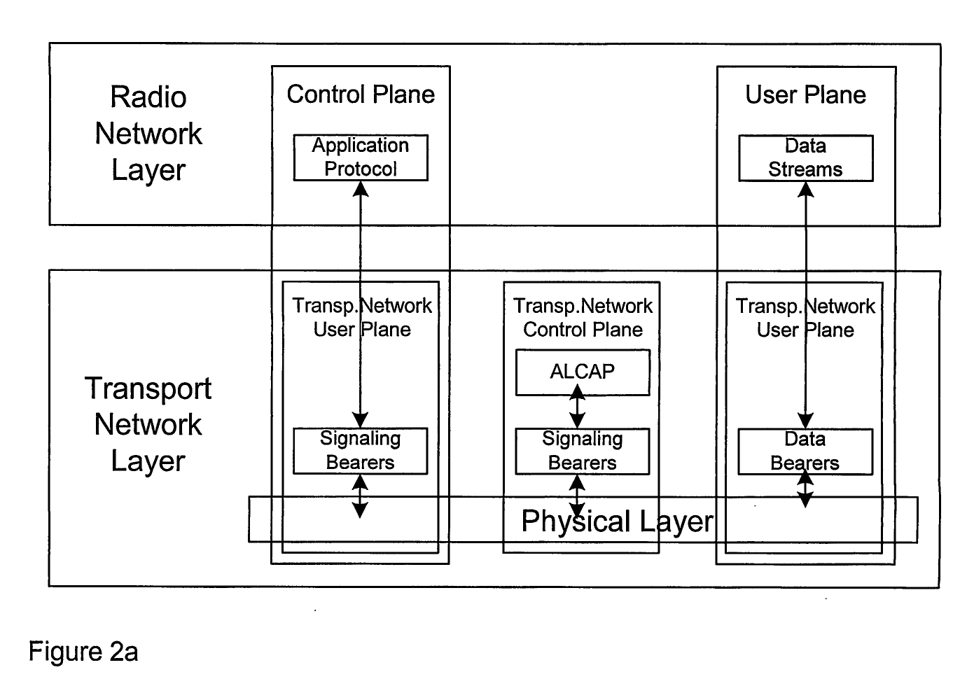

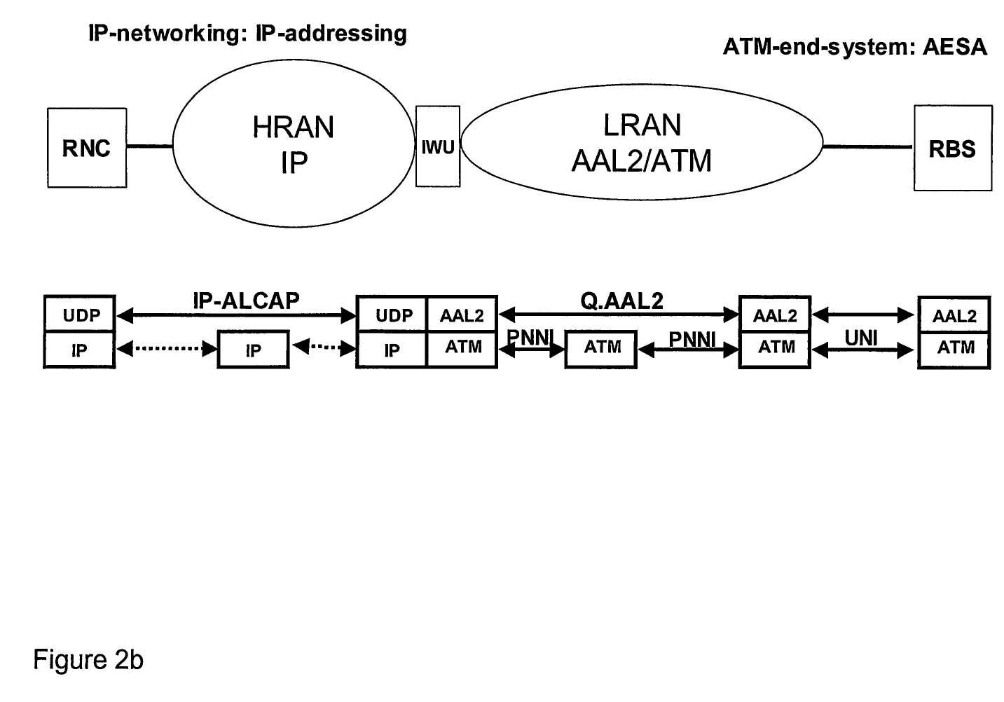

According to a third embodiment of the present invention, the proposed TNL signalling may also be used in a mixed ATM-IP network, in which HRAN is IP based and LRAN is ATM based. An Inter-working Unit (IWU) operates between the ATM and IP network parts, see FIG. 2b. In the user plane, the IWU converts the IP packets to ATM packets, but the IWU is not needed for the control plane, which is an advantage of the present invention.

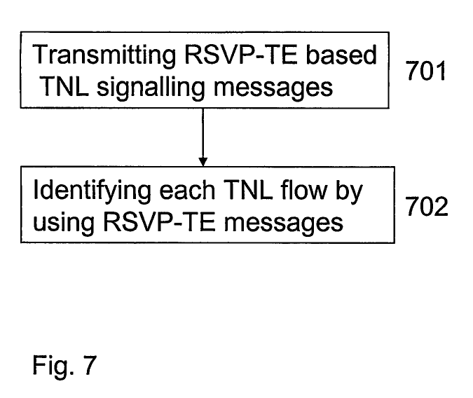

The method according to the present invention is illustrated by the flowchart in FIG. 7. Thus, the method for controlling the user plane of a UMTS Terrestrial Radio Access Network, UTRAN, comprising a first edge node connected via a Transport Network Layer to a second edge node, by using Transport Network Layer, TNL, signalling, comprises the steps of:
701. Transmitting RSVP-TE based TNL signalling messages between said first and second edge nodes for each TNL flow,
702. Identifying each TNL flow by using RSVP-TE messages, wherein the object SESSION and SENDER_TEMPLATE comprises an IP based 5-tuple flow information, which is adapted to be used as a TNL flow identity.

Furthermore, the arrangement according to the present invention comprises means for performing the method of the present invention and the preferred embodiments. Said means may be implemented by software and/or hardware means in a RNC, Node B and/or in an IWU.

In the drawings and specification, there have been disclosed typical preferred embodiments of the invention and, although specific terms are employed, there are used in a generic and descriptive sense only and not for purposes of limitation, the scope of the invention being set forth in the following claims.

1. A method for controlling the user plane of a UMTS Terrestrial Radio Access Network, UTRAN, comprising a first edge node connected via a Transport Network Layer to a second edge node, by using Transport Network Layer, TNL, signalling, the method comprises the step of:
setting up a radio link by using the Node B Application Part between the first and second edge nodes of the UTRAN, the method is characterised in that it comprises the further steps of:
transmitting RSVP-TE based TNL signalling messages between said first and second edge nodes for each TNL flow,
identifying each TNL flow by using RSVP-TE messages, wherein the object SESSION and SENDER_TEMPLATE comprises an IP based 5-tuple flow information, which is adapted to be used as a TNL flow identity.

2. The method according to claim 1, wherein the method comprises the further step of:
establishing one RSVP-TE tunnel for each connection direction between the first edge node and the second edge node.

3. The method according to claim 1, wherein the method comprises the further step of:
initiating the TNL signalling by sending a PATH message comprising at least reservation information such as bandwidth for interior nodes and at least the TNL flow identity.

4. The method according to claim 3, wherein the method comprises the further step of:
processing the reservation information in each interior node between the edge nodes.

5. The method according to claim 3, wherein the method comprises the further step of:
processing the TNL flow identity in the edge nodes.

6. The method according to claim 3, wherein the method comprises the further step of:
responding to said PATH message by transmitting a RESV message comprising standard RSVP-TE objects and PHR and PDR objects in the reverse direction.

7. The method according to claim 3, wherein the method comprises the further step of:
responding to said PATH message by transmitting a RESV message comprising standard RSVP-TE, PHR, PDR objects or AAL2_LABEL_REQUEST or AAL2 LABEL objects in the reverse direction, and
inserting a resource reservation confirmation information in said RESV message.

8. The method according to claim 1, wherein the first edge node is a Radio Network Controller in the UTRAN and the second edge node is a Node B in the UTRAN.

9. The method according to claim 1, wherein the second edge node is a Radio Network Controller in the UTRAN and the first edge node is a Node B in UTRAN.

10. The method according to claim 1, wherein the first edge node is a Radio Network Controller in the UTRAN and the second edge node is an InterWorking Unit between an IP based part of the UTRAN and an AAL2/ATM part of the UTRAN.

11. The method according to claim 1, wherein the second edge node is a Radio Network Controller in the UTRAN and the first edge node is an InterWorking Unit between an IP based part of the UTRAN and an AAL2/ATM part of the UTRAN.

12. The method according to claim 1, wherein the method comprises the further step of:
configuring an AAL2/ATM UTRAN part by sending a PATH message comprising a Channel Identification Value, CID, VPI/VCI values to adjacent nodes along the path of the connection.

13. The method according to claim 12, wherein the object LABEL_REQUEST with ATM Label Range is adapted to carry VPI/VCI values and AAL2_LABEL_REQUEST is adapted to carry CID value.

14. The method according to claim 12, wherein the method comprises the further step of:
responding to said PATH message and said AAL2 label request by transmitting a RESV message comprising at least an ATM LABEL object comprising VPI and VCI and an AAL2 LABEL object comprising CID of the connection.

15. The method according to claim 14, wherein the method comprises the further step of:
processing the LABEL and AAL2_LABEL objects by the same nodes in which LABEL_REQUEST and AAL2_LABEL_REQUEST were originated.

16. The method according to claim 12, wherein the method comprises the further step of:
ensuring the Quality of Service (QoS) in the ATM/AAL2 network part, by using AAL2 CAC.

17. The method according to claim 13, wherein the less significant eight bits of the objects LABEL_REQUEST and the object LABEL with AAL2 label range comprise a CID value

18. The method according to claim 12, when an Inter-working Unit (IWU) operates between the ATM network part and the IP network part, the method comprises the further step of:
translating the Q.AAL2 and the IP-ALCAP messages to said RSVP-TE based TNL signalling messages.

19. An arrangement for controlling the user plane of a UMTS Terrestrial Radio Access Network, UTRAN, comprising a first edge node connected via a Transport Network Layer to a second edge node, by using Transport Network Layer, TNL, signalling, the arrangement comprises means for setting up a radio link by using the Node B Application Part between the first and second edge nodes of the UTRAN, the arrangement is characterised in that the arrangement comprises means for transmitting RSVP-TE based TNL signalling messages between said first and second edge nodes for each TNL flow,
means for identifying each TNL flow by using RSVP-TE messages, wherein the object SESSION and SENDER_TEMPLATE comprises an IP based 5-tuple flow information, which is adapted to used as a TNL flow identity.

20. The arrangement according to claim 19, wherein the arrangement comprises means for establishing one RSVP-TE tunnel for each connection direction between the first edge node and the second edge node.

21. The arrangement according to claim 19, wherein the arrangement comprises means for initiating the TNL signalling by sending a PATH message comprising at least reservation information such as bandwidth for interior nodes and at least the TNL flow identity.

22. The arrangement according to claim 21, wherein the arrangement comprises means for processing the reservation information in each interior node between the edge nodes.

23. The arrangement according to claim 21, wherein the arrangement comprises means for processing the TNL flow identity in the edge nodes.

24. The arrangement according to claim 21, wherein the arrangement comprises means for responding to said PATH message by transmitting a RESV message comprising standard RSVP-TE objects and PHR and PDR objects in the reverse direction.

25. The arrangement according to claim 21, wherein the arrangement comprises means for responding to said PATH message by transmitting a RESV message comprising standard RSVP-TE, PHR, PDR objects or AAL2_LABEL_REQUEST or AAL2 LABEL objects in the reverse direction, and means for inserting a resource reservation confirmation information in said RESV message.

26. The arrangement according to claim 19, wherein the first edge node is a Radio Network Controller in the UTRAN and the second edge node is a Node B in the UTRAN.

27. The arrangement according to claim 19, wherein the second edge node is a Radio Network Controller in the UTRAN and the first edge node is a Node B in UTRAN.

28. The arrangement according to claim 19, wherein the first edge node is a Radio Network Controller in the UTRAN and the second edge node is an InterWorking Unit between an IP based part of the UTRAN and an AAL2/ATM part of the UTRAN.

29. The arrangement according to claim 19, wherein the second edge node is a Radio Network Controller in the UTRAN and the first edge node is an InterWorking Unit between an IP based part of the UTRAN and an AAL2/ATM part of the UTRAN.

30. The arrangement according to claim 19, wherein the arrangement comprises means for configuring an AAL2/ATM UTRAN part by sending a PATH message comprising a Channel Identification CID, VPI/VCI values to adjacent nodes along the path of the connection.

31. The arrangement according to claim 30, wherein the object LABEL_REQUEST with ATM Label Range is adapted to carry VPI/VCI values and AAL2_LABEL_REQUEST is adapted to carry CID value.

32. The arrangement according to claim 30, wherein the arrangement comprises means for responding to said PATH message and said AAL2 label request by transmitting a RESV message comprising at least an ATM LABEL object comprising VPI and VCI and an AAL2 LABEL object comprising CID of the connection.

33. The arrangement according to claim 32, wherein the arrangement comprises means for processing the LABEL and AAL2_LABEL objects by the same nodes in which LABEL_REQUEST and AAL2_LABEL_REQUEST were originated.

34. The arrangement according to claim 30, wherein the arrangement comprises means for ensuring the Quality of Service (QoS) in the ATM/AAL2 network part, by using AAL2 CAC.

35. The arrangement according to claim 31, wherein the less significant eight bits of the objects LABEL_REQUEST and the object LABEL with AAL2 label range comprise a CID value

36. The arrangement according to claim 30, when an Inter-working Unit (IWU) operates between the ATM network part and the IP network part, comprises means for translating the Q.AAL2 and the IP-ALCAP messages to said RSVP-TE based TNL signalling messages.
